(19) United States
(12) Patent Application Publication
(10) Pub. No.: US 2006/0101188 A1
(43) Pub. Date: May 11, 2006

(54) Record carrier with protective linking areas

(75) Inventors: Josephus Arnoldus Henricus Maria Kahlman, Eindhoven (NL); Cornelis Marinus Schep, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/540,699

(22) PCT Filed: Dec. 17, 2003
(86) PCT No.: PCT/IB03/06032

§ 371 Date: Jun. 24, 2005

(30) Foreign Application Priority Data
Dec. 30, 2002 (EP) 02293268.5

(51) Int. Cl. G06F 3/06

(52) U.S. Cl. 711/4; 711/202

(57) ABSTRACT

The invention relates to a record carrier intended to store data. According to the invention, data are intended to be stored in accordance with a standard for creating physical data clusters separated by protective linking areas, said protective linking areas being of different size from linking areas of a writable record carrier intended to store said physical data clusters locked to a pre-recorded wobbled groove in which linking areas are used. The invention serves to prevent bit-by-bit copying of said record carrier onto said writable record carrier. The invention can also serve to control the compatibility of different standards of writable record carrier. Application: Optical storage.

### FIELD OF THE INVENTION

The invention relates to any record carrier intended to store data that are susceptible to be copied. The invention relates to the protection of original data stored on an original pre-recorded record carrier. The invention also relates to the control of the compatibility of rewritable (and writable) record carriers of different standards. Record carriers concerned are, for example, optical discs.

### BACKGROUND OF THE INVENTION

During normal copying, the writing of copied data on such a writable record carrier uses re-encoding of data in such a way that data are locked to a physical sector number related to the wobbled groove of the writable record carrier. The problem of the protection of data that are susceptible to be copied on a writable disc is known from document EP0899733. This document proposes the implementation of a copy prevention method during the manufacture of an optical record carrier by modification of subcode address information of a predetermined pattern of blocks. It is normally not possible to copy incorrect address data onto an optical record carrier, since the address data will be newly generated during the copying process. Such modified subcode address information, called a hidden key, is thus utilized to distinguish between an original record carrier and a copied or non-original record carrier. As the prevention method is implemented during manufacture, it can be used to encrypt data stored on the record carrier. Such hidden keys can thus be hidden in order that normal copying, by applying first demodulation/decoding followed by re-encoding of the data, destroys the hidden keys and renders the copy unplayable. Nevertheless, a bit-by-bit copy arises from copying of data from an original classical record carrier without any decoding/re-encoding. Data are then copied as-it-is, and although the bit errors present on the disc are also copied, the copy method enables the transfer of the hidden keys that are present in the format for the purpose of copy protection. Consequently bit-by-bit copying is a method to get around some copy protection measures like such a hidden channel key on an original record carrier.

### SUMMARY OF THE INVENTION

It is an object of the present invention to propose a record carrier that protects the stored data from being copied bit-by-bit to a writable record carrier.

To this end, the invention proposes a record carrier which is characterized in that data are intended to be stored in accordance with a standard for creating physical data clusters separated by protective linking areas, said protective linking areas being of different size from linking areas of a writable record carrier intended to store data locked to a pre-recorded wobbled groove in which linking areas are used.

For example, in Blu-ray Disc rewritable record carriers, address unit numbers of physical data clusters are conventionally linked to wobble addresses. Said address unit numbers are stored in the data format, for instance in the heavily protected BIS columns of physical clusters in the Blu-ray Disc (BD) format. A physical cluster is delimited by two linking areas.

Such linking areas are used to create margins for the purpose of replacing isolated physical clusters. Thus physical data clusters containing stored data are locked to their absolute position on the disc by linking the address unit numbers to the wobble addresses of the pre-recorded wobbled groove. This also renders possible a fast localization on the writable record carrier. Said linking areas have a specific standardized size for each standard of (re-)writable record carrier.

Readers require a coupling between the wobble address and the address unit number in order to realize the reading of such a (re-)writable disc.

By including protective linking areas of different size on a record carrier intended to store data that need to be protected from a copying onto a writable record carrier, it is avoided that a bit-by-bit copying process will provide a good copy of said record carrier. Effectively, a bit-by-bit copy will imply that the physical data clusters on the (re-)writable record carrier are no longer aligned with the wobble addresses. As a direct consequence, the writable record carrier will not be correctly playable.

According to an advantageous embodiment, said protective linking areas of said record carrier are shorter than the linking areas of the writable record carrier.

According to a preferred embodiment, said protective linking areas of said record carrier are longer than linking areas of the (re-)writable record carrier, and data essential for playability of said record carrier are stored in the protective linking areas of said record carrier.

In a first application, said record carrier is another (re-)writable record carrier of a different standard. In such an application, the invention renders it possible to control the compatibility of several standards intended to store data of a same logical format, i.e. generally belonging to the same family of standards. This may be a commercially valuable feature. Such standards may be the Blue-ray standard, or the Small Form Factor Optical disc (SFFO) standard. Rewritable standards are particularly concerned by the invention, as the issue of random writing is essential.

In a second application, said record carrier is a pre-recorded record carrier including original data. In such an application, said original data are generally pre-recorded data that are distributed by a content owner.

The invention is advantageously combined with a hidden key protection. Normal copying by using de- and encoding of the data is not useful because it destroys the hidden key, bit-by-bit copying leading to an unreadable record carrier.

### BRIEF DESCRIPTION OF THE DRAWINGS

The invention will be described in detail below with reference to the diagrammatic Figures wherein:

FIG. 1a presents a recording unit block as classically implemented in a writable record carrier intended to store data locked to a pre-recorded wobbled groove with linking areas;

FIG. 1b illustrates a recording unit block as implemented in a record carrier according to the invention;

FIG. 2 illustrates the functioning of the invention by illustrating a bit-by-bit copying of a record carrier according to an advantageous embodiment of the invention on a (re-)writable record carrier according to the invention;

FIG. 3 illustrates the functioning of the invention by illustrating a bit-by-bit copying of a record carrier according to a preferred embodiment of the invention on a writable record carrier according to the invention; and

FIG. 4 is a block diagram of a method and an apparatus for manufacturing a record carrier according to the invention.

### DESCRIPTION OF EMBODIMENTS

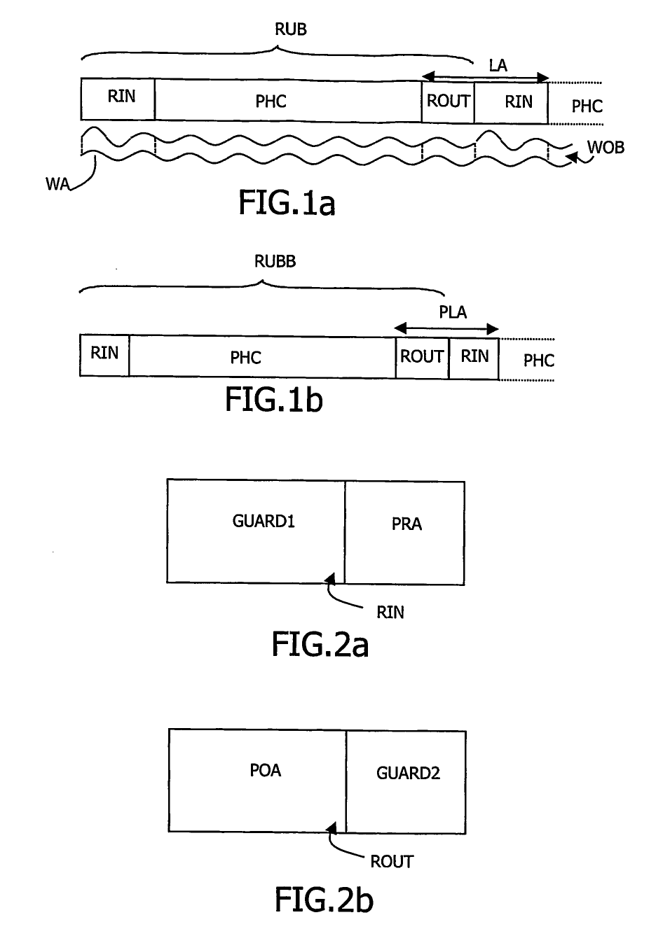

FIG. 1a presents a recording unit block RUB as classically implemented in a writable record carrier intended to store data locked to a pre-recorded wobbled groove WOB with linking areas. The information represented by the pre-recorded wobbled groove is commonly referred to as “absolute time in the pre-groove” (ATIP) or as “addresses in the pre-groove” (ADIP), depending on the standard used. ADIP data contains synchronization information and addresses linked to the physical data as well as sectors information about the disc velocity, write strategy, and disc type.

In the example of Blu-Ray disc, one recording unit block RUB is linked to 3 ADIP words. One ADIP word comprises 19+5 bits of address information e.g. a physical ADIP address. Each ADIP word thus contains one address of 24 bits. One ADIP word comprises 83 ADIP units and one ADIP unit is linked to 2 recording frames that include data. One ADIP unit contains 56 Nominal Wobble Lenghts NWL. Within these 56 NWL, at some positions, wobble periods can be altered from the nominal wobbling. An altered wobble is called a Modulated Mark (MM). A Modulated Mark MM is 3 Nominal Wobble Lengths NWL long. By inserting MMs into the 56 NWLs of an ADIP unit with unique distances between adjacent MMs, different types of ADIP units can be created. In such a way the ADIP units can be used to represent different symbols, like “1” and “0” and “sync”-structures. Modulated Marks MM are formed using a Minimum Shift Keying—cosine variant modulation method and Harmonic Modulated Wave modulation method.

The ADIP units can then be used as basic units for the address format as they can represent sync structures and data bits . . . . The data format for the address is set by combining the ADIP units in ADIP words. So there are 3 addresses per Recording Unit Block. The wobbled groove WOB is modulated along the track by ADIP words so as to provide the localization on the disc. In FIG. 1a, a specific modulation WA allowing to determine a wobble address is schematically represented. In a (re-)writable record carrier intended to store data locked to a pre-recorded wobbled groove WOB using linking areas, a fixed given amount of data to be stored is formatted by a recording apparatus in physical clusters PHC. Such a physical cluster PHC includes data in a logical format that is defined by the standard of the writable record carrier to which the invention relates. Then, said recording apparatus prepares recording unit blocks RUB, each consisting of a data run-in RIN, a physical cluster PHC, and a data run-out ROUT. A liking area LA is constituted by the assembly of a run-out ROUT and of a run-in RIN between two consecutive recorded physical clusters PHC.

The role and content of said run-in RIN and run-out ROUT will be explained in the following. Standards of writable record carrier are often random access formats. Consequently, localization on the record carrier needs to be fast and easy. Moreover, it is necessary that each recording unit block RUB can be read separately from the others. Thus, some specific patterns are written in said linking area to aid signal processing. This is a first function of said run-in RIN and run-out ROUT that constitute said liking areas. Linking areas are also created to prevent overlap in the user data area present in the physical cluster PHC of the RUB during writing.

For example, as illustrated in FIG. 2a, the run-in RIN starts with a band GUARD1 which contains some specific sequences which are well suited to reset electronic circuits before locking and synchronization occurs to read the next RUB. Also, in the Run-in there is a field PRA (after GUARD1) which serves for locking and synchronization of the signal processing.

Then the reading of the next recording unit block RUB is prepared. After the recording unit block RUB has been read, there is a run-out ROUT with a field POA that is used by the signal processing as illustrated in FIG. 2b. The end of data of the previous recording unit block RUB is thus indicated. Then the run-out ROUT includes a band GUARD2 that contains a specific sequence. Said band GUARD2 is continued in the band GUARD1 of the run-in RIN of the next recording unit block RUB.

FIG. 1b presents a recording unit block RUBB for a record carrier of the invention. According to the invention, as shown in FIG. 1b, protective linking areas PLA are inserted on the record carrier of the invention, and such protective linking areas PLA are of a size different from the size of linking areas LA of a writable record carrier on which the copy could occur. In FIG. 1b, RIN is smaller on the record carrier of the invention than on the writable record carrier as illustrated in FIG. 1a.

A record carrier of the invention may be a (re-)writable record carrier of a different format but capable of storing data in the same logical format. In this case, the presence of linking areas PLA is necessary. A record carrier of the invention may alternatively be a pre-recorded record carrier. In this case the linking area PLA has no function. Generally, the read-out is continuous. It may nevertheless be useful for standard consistency with a (re-)writable record carrier to insert some linking area in such a pre-recorded record carrier. Said run-in RIN of a record carrier of the invention may contain data similar to the ones present in the run-in RIN of the writable record carrier or data of different nature. Some possibilities are presented in the following. For example, run-in RIN and run-out ROUT of a record carrier of the invention may contain information such as a copy of different addresses that renders it possible to locate the recording unit block RUB. This may be useful for fast access to stored data.

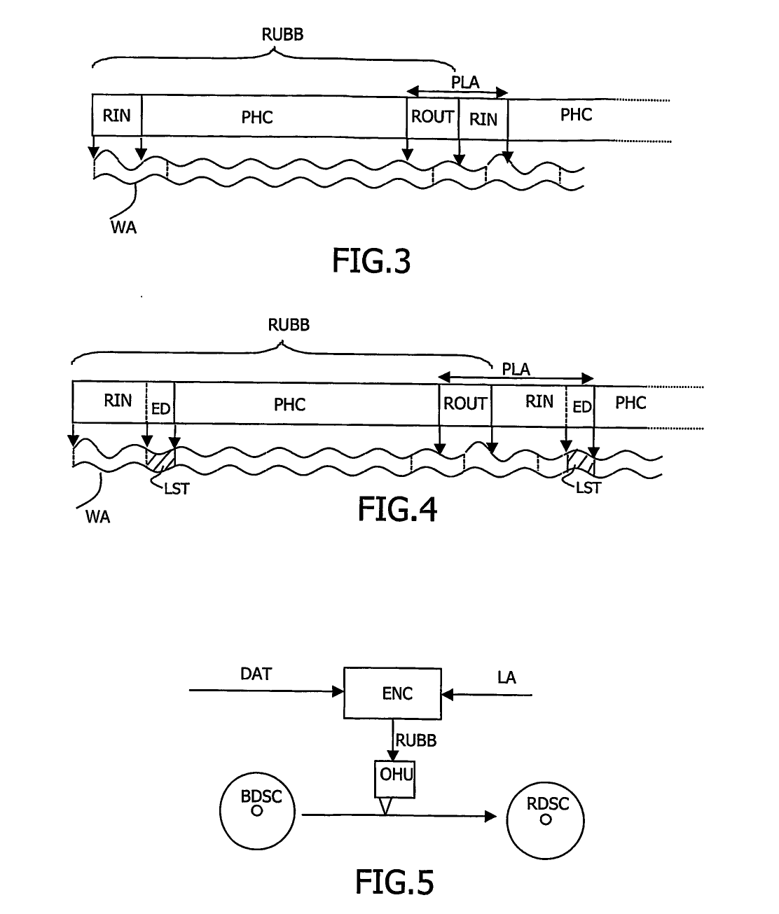

The effects of the invention on a bit-by-bit copy are illustrated in FIG. 3 and FIG. 4. In both Figures, bit-by-bit copying, illustrated by arrows, results in non-alignment between the wobble address WA and the recording unit block RUBB. As a consequence the copy cannot be played. It has to be noted that these Figures are schematic and that, for example in Blu-Ray format, the wobble address occupies a large part of the ADIP words and not only a small part WA at the start of the ADIP words. The non-alignment is consequently present all along the wobble.

In FIGS. 3 and 4, the effect of the non-alignment will be cumulative. After several recording unit blocks RUBB, all recording unit blocks RUBB are totally ‘covered’ with wrong ADIP addresses. The exact number after which a totally wrong covering is obtained depends on the difference in length between the linking areas of the writable record carrier and the protective areas of the record carrier of the invention.

In FIG. 3, the protective linking area PLA between two recording unit blocks RUBB of a record carrier of the invention is shorter than the linking area LA between two recording unit blocks RUBB of a writable record carrier. A non-alignment of the wobble address WA with the RIN and ROUT of two successive recording unit blocks RUBB is observed. The copied record carrier cannot be played correctly. Nevertheless, if there is no additional protection by a hidden key, normal copying by decoding/encoding can be successful. It is effectively possible to decode data read on the record carrier of the invention even if said linking areas are of different size. If there is no additional protection means (for example by a hidden key), the re-encoding allows to copy the record carrier successfully.

In FIG. 4, the protective linking area PLA between two recording unit blocks RUBB of a record carrier of the invention is longer than the linking area LA of the writable record carrier. A non-alignment is also observed in such an embodiment. Moreover, in this case, it is possible to fill in said protective linking areas PLA with essential data ED, especially in the supplementary part that is called extension part. Such essential data ED may be information for copy protection. A protection key may also be stored in such protective linking areas PLA. Information needed by an application whose are dedicated data are stored in the physical cluster PHC may also be advantageously stored in such longer protective linking areas PLA. Thus a hacker cannot shorten the protective linking areas PLA to the size of the linking areas LA of the writable record carrier, not even by decoding/re-encoding, and information is lost in dashed areas LST. Thus, according to the invention, it is possible to prevent bit-by-bit copying as well as normal copying. Effectively, in general, copy protection information should be at least as robust as or more robust than the main data, but it is possible that copy protection information present in the extension part of said protective linking areas is less robust than main data.

In FIGS. 3 and 4, the case of a copy of a pre-recorded record carrier has been studied in more details. In the application of the invention to a (re-)writable standard record carrier intended to store data in the same logical format, the writable record carrier of the invention will have a wobbled groove adapted to the size of said protective linking areas PLA. Linking areas are advantageously a multiple of the size of the ADIP unit. Thus, for example, a (re-)writable record carrier of the invention has protective linking areas PLA of the length of a single ADIP unit, the original (re-)writable record carrier has linking areas LA of the length of two ADIP units. The invention then also renders it possible to control the compatibility between different standards belonging to the same format family, i.e. the same logical data format.

FIG. 5 is a schematic diagram of a recording apparatus for manufacturing a pre-recorded record carrier according to the invention RDSC. This Figure is also illustrative of a method of manufacturing a pre-recorded record carrier RDSC of the invention from a blank record carrier BDSC.

Data DAT to be stored are provided to an encoder ENC as well as a content for said protective linking areas PLA. Said content is such that the protective linking areas PLA are of a size different from the size of linking areas LA of a writable record carrier of a standard on which copying is to be prevented. The encoder ENC then prepares the recording unit blocks RUBB, which are provided to an optical head unit OHU having means for irradiating said blank record carrier BDSC with light. A pre-recorded record carrier according to the invention has protective linking areas PLA of a size different from that of a writable record carrier capable of storing data copied from said pre-recorded record carrier.

A writable record carrier of the invention is obtained by forming a wobbled groove in conformity with said protective linking areas PLA. Any apparatus for manufacturing wobbled grooved record carriers may be used to manufacture a writable record carrier of the invention.

The Figures are illustrative of a special embodiment of the invention and are not restrictive. The invention is a generic solution to prevent bit-by-bit copying for data-wobble locked format.

It will be apparent to those skilled in the art that many modifications and variations may be made to the exemplary embodiments of the present invention set forth above, without departing substantially from the principles of the present invention. All such modifications and variations are intended to be included herein.

1. A record carrier intended to store data, characterized in that data are intended to be stored in accordance with a standard for creating physical data clusters separated by protective linking areas, said protective linking areas being of different size from linking areas of a writable record carrier intended to store said physical data clusters locked to a pre-recorded wobbled groove in which linking areas are used.

2. A record carrier as claimed in claim 1, wherein said record carrier is an optical disc.

3. A record carrier as claimed in claim 1, wherein said protective linking areas of said record carrier are shorter than linking areas of the writable record carrier.

4. A record carrier as claimed in claim 1, wherein said protective linking areas of said record carrier are longer than linking areas of the writable record carrier, data essential for playability of said record carrier being stored in said protective linking areas of said record carrier.

5. A record carrier as claimed in claim 1, wherein said record carrier is another writable record carrier of a different standard.

6. A record carrier as claimed in claim 1, wherein said record carrier is a pre-recorded record carrier including original data.

7. A record carrier as claimed in claim 1, wherein said record carrier also implements a protection using a hidden key.

8. A pre-recorded record carrier manufacturing apparatus, characterized in that said apparatus comprises means for forming recording unit blocks with protective linking areas between physical clusters of data, said linking areas being of different size from linking areas of a (re-)writable record carrier intended to store said physical data clusters locked to a pre-recorded wobbled groove in which linking areas are used.

9. A pre-recorded record carrier manufacturing method, characterized in that said method comprises a step of forming recording unit blocks with protective linking areas between physical clusters of data, said linking areas being of different size from linking areas of a writable record carrier intended to store said physical data clusters locked to a pre-recorded wobbled groove in which linking areas are used.
